(19) United States
(12) Patent Application Publication
(10) Pub. No.: US 2019/0365060 A1
(43) Pub. Date: Dec. 5, 2019

(54) WEARABLE ELECTRONIC DEVICE INCLUDING A SUPERCAPACITOR

(71) Applicant: ZapGo Ltd., Oxford (GB)

(72) Inventors: Hugh Liam SUTHERLAND, Oxford (GB); Stephen David VOLLER, Oxford (GB)

(73) Assignee: ZapGo Ltd., Oxford (GB)

(21) Appl. No.: 16/486,831

(22) PCT Filed: Feb. 16, 2018
(86) PCT No.: PCT/GB2018/050422

§ 371 Date: Aug. 19, 2019

(30) Foreign Application Priority Data
Feb. 17, 2017 (GB) 1702635.2

(51) Int. Cl. A44C 5/00; G06F 1/16; H01G 11/36

(52) U.S. Cl. CPC A44C 5/0007; H01G 11/36; G06F 1/1635; G06F 1/163

(57) ABSTRACT

A wearable electronic device is provided and comprises:
an assembly for carrying out the intended use of the device including a microprocessor and
a strap by means of which the assembly can be attached to the body of the wearer characterised in that the strap includes at least one supercapacitor comprised of nanocarbon-containing electrodes and/or ionic liquid electrolytes and a first connector adapted to connect an external electrical power source to the supercapacitor for purposes of recharging.

This invention relates to an improved wearable electronic device such as a watch, phone, monitor and the like.

Wearable electronic devices powered by batteries such as lithium-ion batteries are known in the art. For example, KR20160129512 describes a battery-powered wrist-wearable electronic device which includes: a main body having at least one information displayed on one surface thereof and having a first connection terminal for electrical connection; a band unit including a flexible battery and a second connection terminal electrically connected to the first connection terminal; a coupling base disposed in the middle of the length of the band portion so that the second connection terminal is exposed to the outside; and a circuit unit for supplying power from the flexible battery to the main body or controlling an electrical connection to supply power from the external to the flexible battery.

US20130222271 discloses a wearable electronic device including detectors for altering the presentation of the data it collects. The patent application itself is primarily orientated to the use of a lithium-ion battery as the sole power source but teaches generally that this may be replaced by an electrochemical supercapacitor without specifying its exact nature or how this might be achieved. Furthermore it does not teach employing an additional supercapacitor as a power reservoir to trickle charge the battery if one is employed.

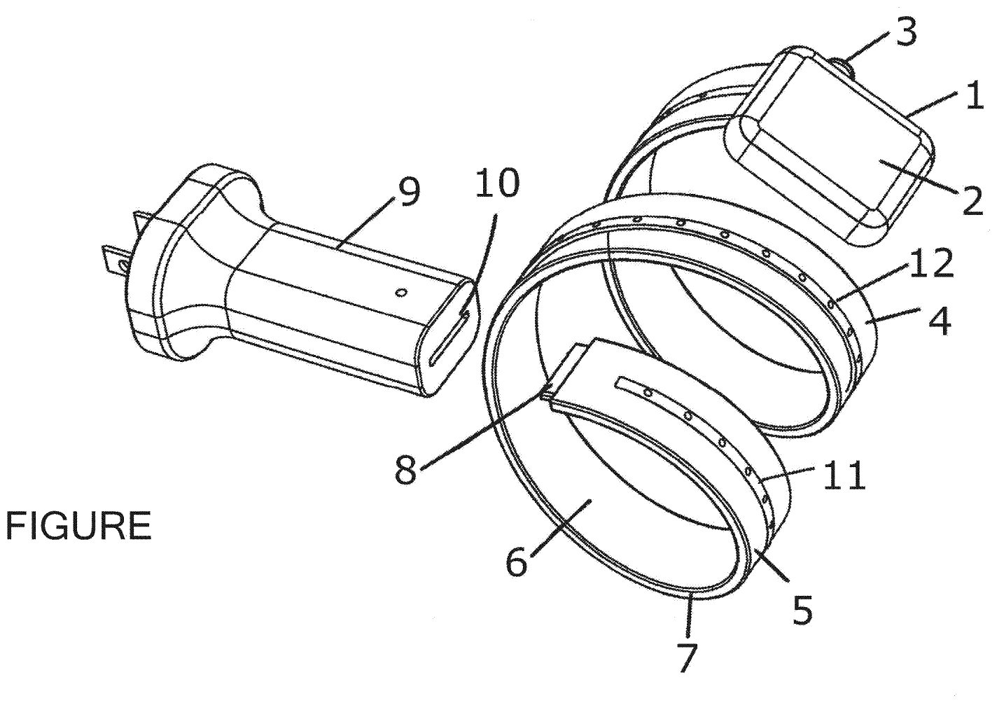

Likewise, WO2016033263 illustrates, in FIGS. 1A and 1B, a wearable electronic device whose design incorporates voids in the strap 24C and 24D which may receiver a lithium-ion battery, supercapacitor or ultracapacitor as alternative sources of power. Again the type of supercapacitor to be used is not specified and there is no teaching of employing an additional supercapacitor as a power reservoir to trickle charge the battery

According to the present invention there is provided a wearable electronic device comprising:

an assembly for carrying out the intended use of the device including a microprocessor and

a strap by means of which the assembly can be attached to the body of the wearer characterised in that the strap includes at least one supercapacitor comprised of nanocarbon-containing electrodes and/or ionic liquid electrolytes and a first connector adapted to connect an external electrical power source to the supercapacitor for purposes of recharging.

As explained below, the assembly and strap my either be separate interconnectable elements of the device or alternatively the assembly can form an integral part of the strap. The strap may be connected to the assembly at one end or both ends or the assembly may be integrated into the strap itself.

In one embodiment, the assembly includes a battery, for example a lithium-ion battery, or a void into which the battery can be introduced for the purposes of facilitating battery change-over. In another embodiment the battery is included within or separately attachable to the strap. In yet another embodiment, the device does not include a battery and the assembly is powered directly by the supercapacitor.

The assembly may further include a monitor element for detecting and measuring a bodily characteristic of the wearer. Examples include monitors for measuring one or more of the wearer's pulse rate, blood-pressure, breathing characteristics, body temperature and other like parameters useful for medical or personal fitness purposes. In another embodiment, the monitor may comprise, for example, a motion-sensor enabling the assembly to function as a pedometer. In yet another embodiment, the assembly may comprise one or more of a clock, GPS unit or it may perform any of the well-known communication and data-transfer functions of a smart-phone or portable media player.

Suitably, the microprocessor will comprise a chip and the assembly will further include a display by means of which information can be provided to the wearer. In one embodiment, this can be an screen, which may be rigid or flexible; for example a touch-sensitive screen, backlit by LEDs or the like. In another, the display may simply comprise one or a series of flashing lights or audio alarms to alert the wearer. In yet another embodiment, the assembly will have Bluetooth and/or wi-fi functionality and/or GPS or mobile telecommunications or data-transfer capability. The assembly may be provided with buttons or touch-sensitive areas to enable the wearer to perform the duties for which the device is designed.

Turning to the strap, it is a feature of the invention that this includes one or more supercapacitor cells which can either provide trickle-charge to the battery or power the device directly. These supercapacitor cell(s) are characterised by including nanocarbon-containing electrodes and/or ionic liquid electrolytes. In one embodiment, they are the high-performance supercapacitors of the type marketed by us as ‘Carbon-Ion™ cells’ or its equivalent ‘C-Ion® cells’ although this nomenclature should not be construed as limiting. Such arrangements of nanocarbon-containing electrodes and ionic liquid electrolytes have been taught at https://www.zapgo.com/wp-content/uploads/2016/09/Carbon-Ion-a-new-category-of-energy-storage-devices-Technical-White-Paper.pdf

In another embodiment, the supercapacitors employed in the devices of the invention comprise cells which are characterised by employing an electrolyte which is non-flammable. By the term ‘non-flammable’ as used herein is meant that the electrolyte is not prone to undergoing ignition and combustion under the normal operating conditions encountered by the energy pack with an allowance for a margin of error (1 to 5%) for any unplanned temperature excursions which might arise; for example during energy supply/charging or any abnormalities which may arise within the environment of use.

In yet another embodiment, the electrolyte used is an ionic liquid is selected from the group consisting of low-melting salt of an alkyl or substituted-alkyl pyridinium, pyridazinium, pyrimidinium, pyrazinium, imidazolium, piperidinium, pyrrolidinium, pyrazolium, thiazolium, oxazolium or triazolium cation. In such a case it is preferred that the counter anion is large, polyatomic, and has a Van der Waals volume in excess of 50 or 100 angstroms (see for example U.S. Pat. No. 5,827,602 which provides illustrative examples to which the reader is directed and which are contemplated as being within the scope of our invention). In one embodiment, this counter-anion is selected for example from tetrafluoroborate hexafluorophosphate, dicyanamide, bis(fluorosulphonyl)imide (FSI), bis(trifluoromethylsulphonyl)imide (TFSI) or bis(perfluoro C₂ to C₄ alkylsulphonyl)imide e.g. bis(perfluoroethylsulphonyl)imide anions. In another preferred embodiment, the ionic liquid is selected from C₁ to C₄ alkyl substituted imidazolium, piperidimium or pyrrolidinium salts of these anions with any permutation of the cations and anions mentioned above being specifically envisaged as disclosed herein. Specific, non-limiting examples based on these salts include 1-ethyl-3-methyl-imidazolium (EMIM) bis(fluorosulphonyl)imide, 1-ethyl-3-methyl-imidazolium bis(trifluoromethylsulphonyl)imide; 1-ethyl-3-methyl-imidazolium bis(perfluoroethylsulphonyl)imide; 1-methyl-1-propylpyrrolidinium bis(fluorosulphonyl)imide; 1-methyl-1-butylpyrrolidinium bis(fluorosulphonyl)imide; 1-methyl-1-propylpyrrolidinium bis(trifluoromethylsulphonyl)imide; 1-methyl-1-butylpyrrolidinium bis(trifluoromethylsulphonyl)imide; 1-ethyl-3-methyl-imidazolium hexafluorophosphate: 1-ethyl-3-methyl-imidazolium dicyanamide; 1-methyl-1-propylpyrrolidinium hexafluorophosphate: 1- methyl-1-propylpyrrolidinium dicyanamide; 1-methyl-1-butylpyrrolidinium hexafluorophosphate or 1-methyl-1-propylpyrrolidinium dicyanamide.

Preferred examples of electrolytes which can be employed include salts or mixtures of salts derived from the following cations; 1-ethyl-3-methylimidazolium (EMIM), 1-butyl-3-methylimidazolium (BMIM), 1-methyl-1-propylpyrrolidinium, N,N-diethyl-N-methyl-N-(2-methoxyethyl)ammonium (DEME), 1-methyl-1-butylpyrrolidinium and the anions tetrafluoroborate, bis(fluorosulphonyl)imide (FSI), bis(trifluoromethylsulphonyl)imide.

The supercapacitor cells of this type, either singularly or in combination, should suitably be capable of storing at least 1000 F (Farads) of capacitance, preferably at least 2000 F, most preferably 3000 F or greater. In one embodiment, they will deliver an output, either singularly or in combination, of at least 1000 mAh for at least 15 minutes; for example from 15 to 60 minutes; or alternatively 60 minutes or longer. They should preferably also be able to operate at a voltage of at least 2.0 v; for example in the alternative ranges 2.7 to 7 v, 3 to 7 v or alternatively even above 7 v

In one preferred embodiment of the invention, each supercapacitor cell employs carbon-containing electrodes comprised of an anode and a cathode; each consisting essentially of an electrically-conductive metal current collector in the form of a thin flexible sheet (for example aluminium, silver or copper foil) coated with a layer comprised of carbon charge-carrying elements. In an alternative embodiment, this layer is rendered essentially free-standing and the metal current collectors dispensed with. In yet another embodiment, at least some of the charge-carrying elements are particles of carbon having an average longest dimension of less than 1 micron, preferably less than 100 nanometres in size. Preferably, these particles exhibit mesoporosity with the mesopores being in the size range 2 to 50 nanometres. In another embodiment, the carbon charge-carrying elements may be supplemented by nanoparticles of materials which can confer a degree of pseudocapacitance behaviour on the supercapacitor cells; for example, salts, hydroxides and oxides of metals such as lithium or transition metals with more than one oxidation state including nickel, manganese, ruthenium, bismuth, tungsten or molybdenum.

In one preferred embodiment, the layer or free-standing electrode is comprised of carbon particles embedded in a conductive polymer binder matrix and is characterised by the weight ratio of the particles to the binder being in the range 0.2:1 to 20:1. In another embodiment, at least some of the carbon particles are nanoparticulate for example graphene particles or carbon nanotubes. In one embodiment a mixture of graphene and carbon nanotubes are employed with an activated carbon also being present. In another suitable embodiment, the carbon particles comprise a mixture of these three components with the activated carbon, carbon nanotubes and graphene being present in the weight ratio 0.5-2000:0.5-100:1; preferably 0.5-1500: 0.5-80:1.

By the term activated carbon is meant any amorphous carbon of high purity (less than 1000 ppm metal or metal salt impurities) whose surface area is typically greater than 500 m²g⁻¹ preferably from 1000 to 3600 m²g⁻¹ and which has an average particle size of less than 10 microns. Such materials are readily available from a number of commercial sources. The carbon nanotubes used typically have an average length in the range 2-500 microns (preferably 100-300 microns) and an average diameter in the range 100-150 nanometres. The nanotubes may be single-or multi-walled or a mixture of both. By the term graphene is meant the allotrope of carbon whose particles are substantially two-dimensional in structure. In extremis, these particles comprise single atomic-layer platelets having a graphitic structure although for the purposes of this invention this component may comprise a small number of such platelets stacked one on top of another e.g. 1 to 20 preferably 1 to 10 platelets. In one embodiment, these platelets are in a non-oxidised form. In another, the platelets independently have average dimensions in the range 1 to 4000 nanometres preferably 20 to 3000 or 10 to 2000 nanometres as measured by transmission electron microscopy. Any known method can be used to manufacture such materials which are also available commercially; for example, under the name Elicarb® sold by Thomas Swann Limited in the United Kingdom.

In another embodiment, the carbon electrode components will further include up to 20%, preferably 1 to 20% by weight of a conducting carbon. Suitably, this conducting carbon comprises a highly conductive non-graphitic carbon having a polycrystalline structure and a surface area in the range 1 to 500 m²g⁻¹. In one embodiment it is a carbon black; for example, one of those material which have been previously used as conducting additive in lithium-ion batteries (for example Timcal SuperC65® and/or Timcal SuperC45).

In one embodiment, the residual moisture in the electrodes after manufacture should be less than 400 ppm; preferably less than 200 ppm; most preferably less than 100 ppm by weight.

Turning to the conductive binder, this is suitably comprised of one or more electrically conductive polymers and is preferably selected from a cellulose derivative, a polymeric elastomer or mixtures thereof. In one embodiment, the cellulose derivative is a carboxyalkyl cellulose for example carboxymethyl cellulose. In another embodiment, the elastomer is a styrene-butadiene rubber or a material having equivalent properties.

Suitably the total charge-bearing surface area of the various carbon components in the layer is >250 m²g⁻¹ preferably >260 m²g⁻¹.

In yet another embodiment, the carbon-containing anode(s) and cathode(s) are asymmetric to one another; in other words, they have differing thicknesses—for example layers of differing thicknesses.

The supercapacitor cells further comprises an ion-permeable membrane disposed within the electrolyte and separating the anodes from the cathodes.

In one embodiment, the strap may further include indicator lighting for showing the wearer the degree to which the supercapacitor(s) are charged. In another, the end of the strap connected to the assembly may include electronics to ensure that DC current is trickle-fed to the assembly and/or battery at the correct rate. It will however be appreciated that these electronics can alternatively be located with the assembly itself.

If the strap is not permanently attached to the assembly, one end may include a second connector designed to cooperate with a corresponding element located on the assembly. In some instances, such an embodiment may be highly beneficial enabling the device to work with replacement straps. Thus in an embodiment of the invention there is provided a strap for use with a corresponding assembly to create a wearable device according to the present invention characterised in that the strap includes at least one supercapacitor or ultra-capacitor or electrochemical capacitor or electrical double layer capacitor (EDLC) or Carbon-Ion™ cell; a first connector to enable the strap to be connected to a source of electrical power and a second connector adapted to cooperate with a corresponding element on the assembly,

The first connector is adapted so that it can connect the supercapacitor(s) to an external source of electrical power. Typically this is a DC source, for example an active USB or Lightning port on a computer or laptop. The first connector may be held in place by a magnet. Alternatively, the DC source can take the form of a mains power unit with integrated AC/DC converter and a first connector socket or plug arrangement. In both cases, the first connector is suitably a USB, micro-USB or Lightning plug or socket (as the case may be) or an alternative design created for similar powering duties. Alternatively, the strap may be adapted so that it can undergo rapid induction-charging; for example by having a first connector which can simply be introduced into holder where such induction charging can take place.

The size and shape of the strap will depend on the device's intended location of use and to some extent the duties required of the assembly. For example, it is envisaged that the strap will come in a variety of forms and designs which may enable it to be worn comfortably around the arms, wrists legs, ankles, waist, chest neck or even the head of the user. In another embodiment, the strap and/or the assembly can be attached to or integrated into an item of clothing. In one embodiment, the strap may further include adjustable fasteners to hold it securely in place. In another, it can be made of a material such as plastic whose resilience enables it to be biased into position.

The strap may be worn around the wrist or arm or attached to clothing or used to carry a bag, case, rucksack or holdall or similar.

The strap and/or assembly may be decorated to improve the device's aesthetic appearance or further improve its functionality if so desired.

A device according to the present invention is now illustrated by the following.

In the attached Figure, a device designed to be worn around the wrist and/or lower arm of a wearer comprises an assembly 1 of thin cuboid appearance on the front face of which is provided LED display screen 2 and operating button 3. The interior of 1 (not shown) includes (a) a microprocessor chip attached to 2 and RAM storage, (2) a void in which a coin-cell lithium-ion battery can be introduced from the back and (3) a heart-rate monitor, clock and wi-fi unit, It also includes ancillary electronics including a means to enable the battery to be trickle-fed from permanently-connected spiral strap 4 whose internal diameter is wide enough for a human arm and hand to introduced by sliding and the application of bias. 4 has a composite structure comprising inner and outer plastic layers 5,6 between which is sandwiched a thin supercapacitor 7 having the same morphology as these layers. 7 is in electrical contact with the electronics within 1 at one end and at the other end is provide with USB plug first connector 8. 8 may be connected to independent AC/DC converter plug 9 provided with USB socket 10 and designed to be plugged into a conventional mains wall socket. 5 is provided with display strip 11 connected to 7 and which includes a series of LED indicator lights 12 which are progressively illuminated/extinguished as 7 charges or is discharged.

1. A wearable electronic device comprising:
an assembly for carrying out the intended use of the device and including a microprocessor and
a strap by means of which the assembly can be attached to the body of the wearer
characterised in that the strap includes at least one supercapacitor comprised of nanocarbon-containing electrodes and/or ionic liquid electrolytes and a first connector adapted to connect an external electrical power source to the supercapacitor for the purpose of recharging.

2. A wearable electronic device as claimed in claim 1 characterised in that the assembly is embedded within the strap.

3. A wearable electronic device as claimed in claim 1 characterised in that assembly further includes a monitor element for monitoring a bodily characteristic of the wearer.

4. A wearable electronic device as claimed in claim 1 characterised in that the assembly or the strap comprises a battery or is provided with a void adapted to receive a battery.

5. A wearable electronic device as claimed in claim 1 characterised in that the assembly comprises at display which is optionally touch-sensitive.

6. A wearable electronic device as claimed in claim 1 characterised in that the assembly includes at least one of the following components; a microprocessor chip, a RAM storage area, a GPS unit, a motion sensor, a Bluetooth unit or a wi-fi unit.

7. A wearable electronic device as claimed in claim 1 characterised in that the strap is detachable from the assembly and is provided with a second connector adapted to be attachable to the assembly via at least one corresponding element.

8. A wearable electronic device as claimed in claim 1 characterised in that the strap has a composite structure and the supercapacitor(s) are sandwiched between layers of plastic or a similar resilient electrical insulator.

9. A wearable electronic device as claimed in claim 1 characterised in that the strap further comprises an indicator strip for indicating the charge status of the supercapacitor(s).

10. A wearable electronic device as claimed in claim 1 characterised in that the first connector is a USB, micro-USB or Lightning plug or socket.

11. A wearable electronic device as claimed in claim 1 characterised by further comprising a mains power unit including an AC/DC an plug or socket compatible with the first connector.

12. A wearable device as claimed in claim 1 characterised in that the nanocarbon-containing electrodes are graphene-containing electrodes.

13. A wearable device as claimed in claim 1 characterised in that the ionic liquid electrolyte is selected from the group consisting of low-melting salts of an alkyl or substituted-alkyl pyridinium, pyridazinium, pyrimidinium, pyrazinium, imidazolium, piperidinium, pyrrolidinium, pyrazolium, thiazolium, oxazolium or triazolium cation.

14. A wearable device as claimed in claim 13 characterised in that corresponding anion employed in the salt is selected from tetrafluoroborate, hexafluorophosphate, dicyanamide, bis(fluorosulphonyl)imide (FSI), bis(trifluoromethylsulphonyl)imide (TFSI) or bis(perfluoro C2 to C4 alkylsulphonyl)imide.

15. A strap for use with a corresponding assembly to create a wearable device according to claim 1 characterised in that it comprises at least one supercapacitor; a first connector to enable the strap to be connected to a source of electrical power and a second connector adapted to cooperate with a corresponding element on the assembly.
